(19) United States
(12) Patent Application Publication
(10) Pub. No.: US 2002/0040108 A1
(43) Pub. Date: Apr. 4, 2002

(54) Use of trioxepans in the process to modify (CO) polymers

(76) Inventors: Rene Gerritsen, Loosdrecht (NL); Andreas H. Hogt, Enschede (NL); John Meijer, Deventer (NL)

Correspondence Address: Richard P. Fennelly, Akzo Nobel Inc., 7 Livingstone Avenue, Dobbs Ferry, NY, 10522, US

(21) Appl. No.: 09/930,402

(22) Filed: Aug. 15, 2001

Related U.S. Application Data
(60) Provisional application No. 60/225,314, filed on Aug. 15, 2000.

(30) Foreign Application Priority Data
Nov. 8, 2000 (EP) 00203888.3

(51) Int. Cl. C08F 212/08

(52) U.S. Cl. 525/333.3; 525/387

(57) ABSTRACT

The invention relates to a polymer modification process wherein the rheology of one or more (co)polymers is modified by contacting the (co)polymer with at least one decomposing peroxide of the formula,

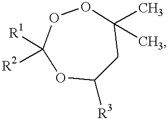

, wherein R¹⁻³ are independently selected from substituted or unsubstituted hydrocarbyl groups. The modification process can be useful to obtain a modified resin or to enhance the flame retardancy of (expanded) styrenic resins.

The present invention relates to the use of trioxepan compounds, or substituted 1,2,4-trioxacycloheptanes, in the process to modify (co) polymers. The trioxepans were found to be particularly suitable for use in processes where a (co)polymer is to be degraded in a controlled way. Two examples of processes where a (co)polymer is degraded are: the process to modify the rheology of polypropylene (PP), also known as vis-breaking, and the process which occurs when a flame retardant polystyrene is subjected to fire conditions.

Presently, depending on the application, various free radical-forming agents are used in controlled degradation processes. Typically, 2,5-di-tert. butylperoxy-2,5-dimethyl hexane is used in modification reactions such as the process to modify the rheology of PP. Alternative products have been proposed for this process, such as cyclic ketone peroxides, see WO 96/03444. The products described in WO 96/03444 give less objectionable by-products and are more cost efficient. To make polystyrenics, especially expanded polystyrene, more flame retardant, typically a free radical-generating species is used together with a halogenated compound, such as hexa-bromo cyclododecane. It is believed that the halogenated compound will decompose under fire conditions, resulting in the liberation of volatile halogenated species. The free radical-generating species assist in obtaining a more flame retarded product by, inter alia, triggering a polystyrene degradation process. The degraded styrenic polymer, with a lower molecular weight and, consequently, a higher melt flow, is expected to flow away from the flame front, causing a reduction of the amount of combustible material near the flame front, thus reducing the fire hazard. Conventionally, products like dicumyl peroxide and 2,3-dimethyl-2,3-diphenyl butane are used for this purpose.

Although the conventional products have proven themselves in many uses, there is a need for even more efficient products/processes. Particularly in the process to make polypropylene with a high MFI (greater than 100 g/10 min when analyzed in accordance with ASTM D 1238 (230° C./2.16 kg)), meaning that PP with a low molecular weight is produced, conventional peroxides are not efficient enough. Although it is possible to use high quantities of one or more of the conventional peroxides in order to produce such high-MFI material, one typically refrains from doing so because, inevitably, a large amount of undesired peroxide decomposition products will be formed. In a search to find more efficient peroxides that are suitable for use in processes to make CR-PP, preferably with a high MFI, unexpectedly a specific family of peroxides fulfilling the requirements was found. Also, the conventional flame retardant synergists for (expanded) polystyrenics are known to suffer from being either too reactive, which causes them to decompose already in the polymerization process and be incorporated into the resin, or not reactive enough, so that they survive the polymerization process but are not activated in time and, therefore, do not show an effective flame retardancy.

Surprisingly, we have found that 1,2,4-trioxacycloheptane compounds of formula I

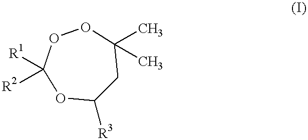

are very useful in polymer modification processes, particularly degradation processes. R¹⁻³ of formula I are independently selected from hydrogen and substituted or unsubstituted hydrocarbyl groups, while two of the groups R¹⁻³ may be connected to form a (substituted) cycloalkyl ring. Preferably, R¹⁻³ are independently selected from the group consisting of hydrogen, C₁-C₂₀ alkyl, C₃-C₂₀ cycloalkyl, C₆-C₂₀ aryl, C₇-C₂₀ aralkyl, and C₇-C₂₀ alkaryl, which groups may include linear or branched alkyl moieties, with each of R¹-R³ optionally being substituted with one or more groups selected from hydroxy, alkoxy, linear or branched alkyl, aryloxy, halogen, ester, carboxy, nitrile, and amido. Preferably, R¹ and R³ are selected from hydrogen and lower alkyl groups, such as methyl, ethyl, and isopropyl, methyl and ethyl being most preferred. R² is preferably selected from hydrogen, methyl, ethyl, isopropyl, iso-butyl, tert-butyl, amyl, iso-amyl, cyclohexyl, phenyl, CH₃C(O)CH₂—, C₂H₅OC(O)CH₂—, HOC(CH₃)₂CH₂—, and

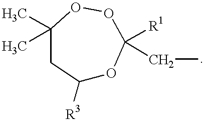

As for the conventional free radical-generating species, it is desired that highly concentrated or pure compounds can be used to minimize the introduction of foreign material into the resin. Hence, in a preferred embodiment the products according to the invention do not contain undesired phlegmatizers (diluents) while still safe. Depending on the desired decomposition rate of the products according to the invention, this was found to be feasible by a careful selection of groups R¹ to R³, as can be determined using conventional techniques, such as Pressure Vessel tests, the Self Accelerating Decomposition Temperature, and the like, as is known in the art. Although the trioxepans according to the invention are pre-eminently suited to make high-MFI PP, they can be used in any process where the rheology of PP is changed by means of a controlled degradation mechanism, and in any process where the degradation of a polymer with free radicals is feasible, such as in processes with polystyrenics near a flame front. It is noted that certain trioxepans are known. See for instance Kirk & Othmer's Encyclopedia of Chem. Tech., 3^{rd} Ed, Vol. 17, page 57, disclosing a 1,2,4-trioxacycloheptane of formula

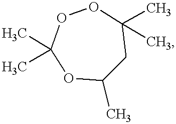

, and WO 98/50354 disclosing four related trioxepan compounds, including the product of formula

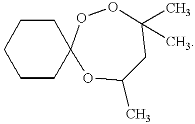

WO 98/50354 furthermore discloses the use of these compounds together with a co-agent in cross-linking processes.

The trioxepans for use according to the present invention can be synthesized in a conventional way, for example by reacting HOC(CH₃)HCH₂C(CH₃)₂OOH with a ketone, typically in the presence of a catalyst and followed by purification steps. Such a procedure is disclosed, for instance, in WO 98/50354 (see Example 1).

Suitable ketones for use in the synthesis of the present peroxides include, for example, acetone, acetophenone, methyl-n-amyl ketone, ethylbutyl ketone, ethylpropyl ketone, methylisoamyl ketone, methylheptyl ketone, methylhexyl ketone, eihylamyl ketone, dimethyl ketone, diethylketone, dipropyl ketone, methylethyl ketone, methyliso-butyl ketone, methyliso-propyl ketone, methylpropyl ketone, methyl-t-butyl ketone, iso-butylheptyl ketone, diiso-butyl ketone, 2,4-pentanedione, 2,4-hexanedione, 2,4-heptanedione, 3,5-heptanedione, 3,5-octanedione, 5-methyl-2,4-hexanedione, 2,6-dimethyl-3,5-heptanedione, 2,4-octanedione, 5,5-dimethyl-2,4-hexanedione, 6-methyl-2,4-heptanedione, 1-phenyl-1,3-butanedione, 1-phenyl-1,3-pentanedione, 1,3-diphenyl-1,3-propanedione, 1 -phenyl-2,4-pentanedione, methylbenzyl ketone, phenylmethyl ketone, phenylethyl ketone, methylchloromethyl ketone, methylbromomethyl ketone, and coupling products thereof. Of course, other ketones having the appropriate R groups corresponding to the peroxides of formula I can be employed, as well as mixtures of two or more different ketones.

Examples of preferred ketones are acetone, methylethyl ketone (any isomer), diethyl ketone (any isomer), methylpropyl ketone (any isomer), methylbutyl ketone (any isomer), methylamyl ketone (any isomer), methylhexyl ketone (any isomer), methylheptyl ketone (any isomer), ethylpropyl ketone (any isomer), ethylbutyl ketone (any isomer), ethylamyl ketone (any isomer), ethylhexyl ketone (any isomer), cyclohexanone, acetylacetone, ethylacetoacetate, diacetone alcohol, and mixtures thereof.

The peroxides can be prepared, transported, stored, and applied as such or in the form of powders, granules, pellets, pastilles, flakes, slabs, pastes, and solutions. These formulations may optionally be phlegmatized, as necessary, depending on the particular peroxide and its concentration in the formulation.

Which of these forms is to be preferred depends in part on the ease of feeding the peroxide into closed systems. Also, considerations of safety may play a role to the extent that phlegmatizers may have to be incorporated into certain compositions to ensure their safety. As examples of suitable phlegmatizers may be mentioned solid carrier materials such as polymers, silica, chalk, clay, inert plasticizers, solvents, and inert diluents such as silicone oils, white oils, and water.

The present peroxides are exceptionally well suited for use in the modification of thermoplastics or thermoplastic elastomers where the molecular weight (distribution) is modified by means of peroxides in such a way that thermoplastics and/or thermoplastic elastomers with different rheological properties are produced. More particularly, such processes do not extend to processes where duromers or non-thermoplastic elastomers are formed. The terms are used in their conventional meaning as disclosed in, for instance, Chapter 1.3 of W. Hofmann's Rubber technology handbook (Carl Hanser Verlag, 1989). The peroxides can be employed in processes such as the degradation of polyolefins such as polypropylene and copolymers thereof, the grafting of monomers onto polymers such as polyethers, polyolefins, and elastomers, and the functionalization of polyolefins in the case of functional group-containing peroxides, but, as said above, they can also be used for degradation processes near a flame front.

Preferred (co)polymers degraded or functionalized in the process according to the invention include isotactic polypropylene, a-tactic polypropylene, syndiotactic polypropylene, alkylene/propylene copolymers such as ethylene/propylene random and block copolymers; propylene/diene monomer copolymers, propylene/styrene copolymers, poly(butene-1), poly(butene-2), polyisobutene, isoprene/isobutylene copolymers, chlorinated isoprene/ isobutylene copolymers, poly(methylpentene), polyvinyl alcohol, polystyrene, poly(α-methyl)styrene, 2,6-dimethyl polyphenylene oxide, styrenics, and mixtures or blends of these polymers and/or with other non-degradable polymers. Typically, with the degradation some properties of the (co)polymer are improved, such as tenacity of fibres, warpage of injection moulded articles, the transparency of polymer films and/or flowability away from a flame front. The modification process of the present invention is particularly advantageous for various polypropylene processes such as fibre spinning, high speed injection moulding, and melt-blowing of non-wovens.

It is noted that, depending on the degree of degradation or functionalization that is obtained, the process according to the invention may be used to recycle (waste) polymeric material into a valuable feedstock and/or fuel stream which is easier to handle than the polymeric starting material.

In general, the trioxepans may be brought into contact with the (co)polymer in various ways, depending upon the particular object of the modification process. For example, if surface modification of a three-dimensional polymeric object is desired, the peroxide may be applied to the surface of the material to be modified. Alternatively, if it is desired to modify the (co)polymer homogeneously throughout the (co)polymeric matrix, then the peroxide may be mixed with the material to be modified, which material may be in the molten state, in the form of a solution, or, in the case of an elastomer, in a plastic state. It is also possible to mix the (co)polymer, in the powdered form, with the peroxide. To accomplish homogeneous mixing of the unmodified (co)polymer with the peroxide, most conventional mixing apparatus may be used. Typical mixing apparatus include kneaders, internal mixers, and (mixing) extruding equipment. Should mixing be a problem for a particular material because of its high melting point, for example, the (co)polymer can first be modified at its surface while in the solid state and subsequently melted and mixed. Furthermore, if polymerization processes and handling of the resulting polymer so allow, the trioxepans may also be incorporated into the (co)polymer during the (co)polymerization step. As another alternative route, the (co)polymer may be dissolved in a solvent and the trioxepan can then be added to this solution to get a homogeneous distribution. The modification reaction can be carried out in the solution or after obtaining the polymer with trioxepan from it, for example by removing the solvent by evaporation or by precipitation of the polymer, e.g., by cooling the mixture or by the addition of a non-solvent.

An important practical aspect of the present invention is that the moment when the trioxepan and the (co)polymer are brought into contact with each other, as well as the moment when the peroxide is to react with the (co)polymer, can be chosen independently of the other usual polymer processing steps, including the introduction of additives, shaping, etc. For instance, the modification may be done before other additives are introduced into the polymer or after the introduction of other additives. More importantly, it is possible to accomplish the present polymer modification during a polymer shaping step such as extrusion, compression moulding, blow moulding or injection moulding. The present polymer modification process is most preferably carried out in an extrusion apparatus. When a trioxepan is used to improve the flame retardancy of a polymer, it is preferred to incorporate it into the polymer before or during the shaping step of the final article, so that the final article will enjoy the improved flame retardancy. More preferably, flame retardant polystyrene resins are produced in a suspension polymerization wherein the trioxepan is already present during (part of) the polymerization process.

The word “(co)polymer” as used in this application should be interpreted to mean “polymers and copolymers.”

In general, any (co)polymer comprising abstractable hydrogen atoms can be modified by the present process. The (co)polymer material treated by the process of the present invention may be in any physical form including finely divided particles (flake), pellets, film, sheet, in the melt, in solution, and the like. In the preferred embodiments of the present invention the (co)polymeric material is in the finely divided form suitable for powder modification in a substantially oxygen-free atmosphere, in the melt form suitable for modification in an air-containing atmosphere or a nitrogen atmosphere, in solution in a suitable solvent, or in the form of a shaped article.

The amount of peroxide used in the modification process of the present invention should be effective for achieving significant modification when treating a (co)polymer.

More particularly, from 0.001-15.0 weight per cent of peroxide, based on the weight of the (co)polymer, should be employed. More preferably, from 0.005-10.0 weight per cent is employed. Most preferably, an amount of 0.01-5.0 weight percent is employed.

During modification, the (co)polymer may also contain the usual polymer additives. As examples of such additives may be mentioned: stabilizers such as inhibitors of oxidative, thermal or ultraviolet degradation, lubricants, extender oils, pH controlling substances such as calcium carbonate, release agents, colorants, reinforcing or non-reinforcing fillers such as silica, clay, chalk, carbon black, and fibrous materials such as glass fibres, nucleating agents, plasticizers, accelerators, flame retardants such as halogenated species, and cross-linking agents such as other types of peroxide and sulfur. These additives may be employed in the usual amounts.

The modification may be carried out in the usual manner, such as heating the (co)polymer in the presence of one or more of the peroxides of formula I, such that the (co)polymer melts and the peroxide decomposes. Usually, a temperature of 50-350° C., more preferably, 100-300° C., is employed. The heating time generally is between 0.1 and 30 minutes and, more preferably, 0.5-5 minutes. Degradation is most preferably carried out in an extrusion apparatus or on a finished article.

The (co)polymer modification process of the present invention is also useful for the grafting of monomers onto polymers or for the production of graft copolymers. However, such a grafting process is a less preferred embodiment of the present invention. Examples of suitable (co)polymers which, according to this embodiment, can be grafted by means of the trioxepans are copolymers and block copolymers of conjugated 1,3-dienes, and one or more copolymerizable monoethylenically unsaturated monomers such as aromatic monovinylidene hydrocarbons, halogenated aromatic monovinylidene hydrocarbons, (meth)acrylonitrile, alkyl (meth)acrylates, acrylamides, unsaturated ketones, vinyl esters, vinylidenes, and vinyl halides; ethylene/propylene copolymers and ethylene/propylene copolymers with other (poly)unsaturated compounds such as hexadiene-1,4, dicyclopentadiene, and 5-ethylidene norbornene; polyolefins such as polyethylene, polypropylene, and copolymers thereof; and polyols including polyols which are essentially free of ethylenic unsaturation. Such polyols include polyalkylene polyether polyols having from 2-6 carbon atoms per monomeric unit and an Mn of 400-2000, polyhydroxyl-containing polyesters, hydroxy-terminated polyesters, and aliphatic polyols.

Suitable monomers for grafting onto the above-mentioned polymers using the process of the present invention are olefinic or ethylenically unsaturated monomers such as: substituted or unsubstituted vinyl aromatic monomers including styrene and α-methylstyrene; ethylenically unsaturated carboxylic acids and derivatives thereof such as (meth)acrylic acids, (meth)acrylic esters and glycidyl methacrylate; ethylenically unsaturated nitriles and amides such as acrylonitrile, methacrylonitrile, and acrylamide; substituted or unsubstituted ethylenically unsaturated monomers such as butadiene; vinyl esters such as vinyl acetate and vinyl propionate; ethylenically unsaturated dicarboxylic acids and their derivatives including mono- and diesters, anhydrides, and imides, such as maleic anhydride, citraconic anhydride, citraconic acid, itaconic acid, nadic anhydride, maleic acid, aryl, alkyl, and aralkyl citraconimides and maleimides; vinyl halogenides such as vinyl chloride and vinylidene chloride; olefins such as isobutene and 4-methylpentene; and epoxides.

In the grafting process, the ratio of the polymer to the grafting monomer is from 99:1 to 1:50. Again, the conventional grafting processes, conditions, and apparatus may be employed to achieve grafting with the peroxides of formula I of the present invention.

Finally, the modification process of the present invention can be employed to introduce functional groups into (co)polymers. Such a modification process is not the most preferred process. It may be carried out by employing a peroxide of formula I which contains one or more functional “R” groups attached thereto. These functional groups will remain intact in the free radicals formed by the trioxepan and thus are introduced into the modified (co)polymer. Conventional polymer modification conditions and apparatus may be used to achieve this object of the present invention.

Experimental

Chemicals used:

Borealis® HC001A-B1 homo-polypropylene powder (PP) ex Borealis

lrganox®1010 ex Ciba Specialty Chemicals

Lucidol® W75 (dibenzoyl peroxide) ex Akzo Nobel

Trigonox® 117 (tert-butylperoxy 2-ethylhexyl carbonate) ex Akzo Nobel

Trigonox® 101 (2,5-di-tert.butylperoxy-2,5-dimethyl hexane) ex Akzo Nobel

Trigonox® 301 (3,6,9-triethyl-3,6,9-trimethyl-1,4,7-triperoxononane) ex Akzo Nobel

Perkadox® 30 (2,3-dimethyl-2,3-diphenyl butane) ex Akzo Nobel

Nacconol® 90 F (sodium dodecyl benzene sulphonate) ex Stephan Chemie

Gohsenol® C500 (PVA) ex Nippon Gohsei

Tricalcium phosphate C13-08, (TCP) ex Budenheim

The peroxides according to the invention were synthesized in our laboratory.

All other chemicals used were supplied by Acros Chemicals, analytical quality, and used without further purification.

### EXAMPLES 1-17 AND COMPARATIVE EXAMPLES A-G

In these examples the peroxides (when used) were dissolved in dichloromethane (approx. 5% by weight solution) and mixed with the PP in an amount such that 0.005% or 0.01% by weight of active oxygen was introduced (based on the weight of the polypropylene). Also 0.1% by weight, based on the weight of the PP, of Irganox® 1010 stabilizer was mixed in. The mixtures were placed in a cupboard overnight at room temperature to remove the dichloromethane. The resulting mixture was fed into a Haake Rheocord® system 40 with Rheomex® TW100 intensive mixing screws using a Plasticolor 2000 single screw pump with screwhousing type 15/22. In order to maintain low-oxygen conditions, nitrogen was introduced into the hopper (2.5 l/minute) and around the die (9 l/minute). During extrusion the screw speed was set to 50 rpm and the temperature settings were 190/250/250/250° C. (condition 1), 160/225/225/225° C. (condition 2), or 190/200/200/200° C. (condition 3).

The resulting strand was cooled using a water bath and granulated using an Automatik® ASG5 granulator. Before analysis, the granules were dried overnight at 60° C.

The MFI of the polymer was analyzed in the conventional way using method ASTM D 1238 (230° C./2.16 kg).

The volatile content of a polymer was determined by twice extracting a sample of 2.500 g of the polymer with 5 ml of dichloromethane at room temperature for 24 hours. The two portions of dichloromethane were combined. The resulting solution was analyzed using a capillary GC, equipped with a fused silica WCOT, 30 m×0.32 mm column with polar wax DB (film thickness 0.22 μm). Helium was used as carrier gas (40 cm/s). The sample volume was 0.5 μl. The injector temperature was 150° C., the detector temperature 260° C., and the temperature of the column was 30° C. for 3 minutes, ramped to 275° C. at a rate of 8° C./min, and kept at 275° C. for 5 minutes.

The following results were obtained:

| | | | | | | Vola- |
|---|---|---|---|---|---|---|
| | | Act. O in | Extr. | Torque | MFI | tiles |
| Ex. | Peroxide | PP | cond. | (Nm) | (g/10 min) | Area % |
| 1 | Formula I | 0.005% | 1 | 16 | 82 | — |
| 2 | Formula I | 0.010% | 1 | 13 | 215 | 21 |
| 3 | Formula I | 0.010% | 2 | 25 | 292 | — |
| 4 | Formula II | 0.005% | 2 | 29 | 116 | — |
| 5 | Formula II | 0.010% | 2 | 25 | 265 | 33 |
| 6 | Formula III | 0.016% | 3 | 18 | 132 | — |
| 7 | Formula III | 0.032% | 3 | 17 | 370 | — |
| 8 | Formula IV | 0.016% | 3 | 20 | 46 | — |
| 9 | Formula IV | 0.032% | 3 | 16 | 120 | — |
| 10 | Formula V | 0.005% | 1 | 19 | 177 | — |
| 11 | Formula V | 0.010% | 1 | 16 | >400 | — |
| 12 | Formula VI | 0.005% | 1 | 16 | 158 | — |
| 13 | Formula VI | 0.010% | 1 | 15 | >400 | — |
| 14 | Formula VII | 0.005% | 1 | 16 | 116 | — |
| 15 | Formula VII | 0.010% | 1 | 14 | 249 | — |
| 16 | Formula VIII | 0.010% | 2 | 26 | 228 | — |
| 17 | Formula IX | 0.010% | 2 | 32 | 14 | — |
| A | None | 0 | 2 | 38 | 3 | 0 |
| B | None | 0 | 1 | 32 | 3 | — |
| C | Trigonox ® 101 | 0.005% | 2 | 34 | 30 | — |
| D | Trigonox ® 101 | 0.010% | 2 | 32 | 71 | 24 |
| E | Trigonox ® 301 | 0.005% | 1 | 17 | 36 | — |
| F | Trigonox ® 301 | 0.010% | 1 | 18 | 84 | — |
| G | Trigonox ® 301 | 0.010% | 2 | 28 | 88 | — |

— = not determined

Wherein:

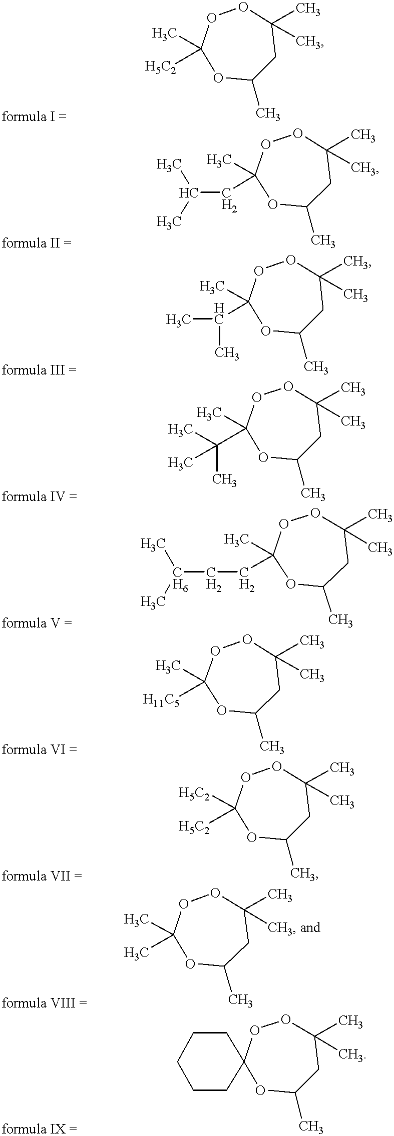

These examples show that the process according to the invention is very suitable for making PP with a lower molecular weight, particularly high-MFI PP. Based on the results, the volatiles content in PP treated in accordance with the invention is expected to be lower than in conventionally treated PP with the same MFI.

### EXAMPLE 18 AND COMPARATIVE EXAMPLE H

In these examples either a peroxide of formula I or Perkadox® 30 was used as a flame retardant synergist in expanded polystyrene foam. Using a conventional suspension polymerization process, the following recipe was polymerized:

| | | |
|---|---|---|
| Water | 260 | g |
| Styrene | 250 | g |
| Tricalcium phosphate | 1.25 | g |
| HBCD | 1.25 | g |
| Gohsenol ® C500 | 50 | mg |
| Nacconol 90F | 20 | mg |
| Lucidol ® W75 | 0.98 | meq/100 g styrene |
| Trigonox ® 117 | 0.46 | meq/100 g styrene |
| Synergist | 0.31 | g/100 g styrene |

The following temperature profile was used during the polymerization:

| | |
|---|---|
| 20-90° C. | 45 min |
| 90° C. | 255 min (first stage) |
| 90-120° C. | 60 min |
| 120° C. | 120 min (second stage) |
| 120° C.-30° C. | 30 min (cooling) |

Until 15 minutes before the end of the first stage the reactor was open to the atmosphere. Then the reactor was closed, and 20 g pentane were added by means of a high-pressure pump. After cooling to 30° C., the reaction was acidified with HCl to remove the TCP, and the EPS beads were filtered off. The beads were washed with demineralized water to pH>6, washed with water containing 25 mg/kg of Armostat® 400, and dried for 5 hours at room temperature. The beads were foamed into blocks from which specimens were cut using a hot wire, for evaluation in accordance with test method ISO 4589 for the Limitative Oxygen Index (LOI).

In Example 18 a trioxepan of formula I was used, while in Comparative Example H Perkadox® 30 was used.

The foam of Example 15 with a density of 19 kg.m⁻³ had an LOI of 24.0 while the foam of Comparative Example H with a density of 20 kg.m⁻³ had an LOI of 23.5, showing the effectiveness of the products according to the invention in a degradation process near a flame front. A blank foam with a density of 19 kg.m⁻³ that did not contain any HBCD or synergist had an LOI of 20.0.

We claim:

1. A process wherein the rheology of one or more (co)polymers is modified by means of free radicals, by reacting the (co)polymer with free radicals from at least one compound of the formula 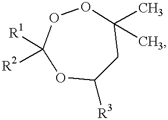
, wherein R¹⁻³ are independently selected from hydrogen and substituted or unsubstituted hydrocarbyl groups, and wherein two of the groups R¹⁻³ may be connected to form a substituted or unsubstituted cycloalkyl ring.

2. A process according to claim 1 wherein R¹⁻³ are independently selected from the group consisting of hydrogen, C₁-C₂₀ alkyl, C₃-C₂₀ cycloalkyl, C₆-C₂₀ aryl, C₇-C₂₀ aralkyl, and C₇-C₂₀ alkaryl, which groups may include linear or branched alkyl moieties; and each of R¹-R³ optionally is substituted with one or more groups selected from hydroxy, alkoxy, linear or branched alkyl, aryloxy, halogen, ester, carboxy, nitrile, and amido.

3. A process according to claim 1 or 2 wherein R¹ and R³ are independently selected from lower alkyl groups and R² is selected from the group consisting of hydrogen, methyl, ethyl, iso-propyl, iso-butyl, tert-butyl, amyl, iso-amyl, cyclohexyl, phenyl, CH₃C(O)CH₂—, C₂H₅OC(O)CH₂—, HOC(CH₃)₂CH₂— and

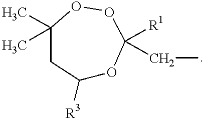

4. A process according to claim 3 wherein R¹ and R³ are independently selected from the group consisting of hydrogen, methyl, ethyl, and isopropyl.

5. A process according to claim 4 wherein R¹ and R³ are methyl.

6. A process according to any one of the preceding claims wherein the molecular weight of a propylene (co)polymer is reduced.

7. A modified (co)polymer obtainable by the process of any one of the preceding claims and articles made thereof.

8. A process according to any one of claims 1-6 wherein the (co)polymer is flame retardant polystyrene, preferably expanded polystyrene, containing from 0.001 to 15.0 weight percent of at least one free radical source of the formula 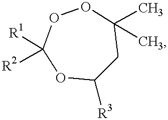
R¹⁻³ having the meaning as given in claim 1, and the process occurs at the flame front.

9. Flame retardant polystyrene, preferably expanded polystyrene, containing from 0.001 to 15.0 weight percent of at least one free radical source of the formula 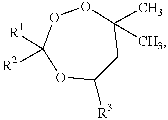
R¹⁻³ having the meaning as given in claim 1, suitable for use in the process of claims 1-6.

10. Use of a degraded polymeric material obtained in a process according to any one of claims 1-6 as a feedstock or fuel source.
